(19) United States
(12) Patent Application Publication
(10) Pub. No.: US 2009/0250941 A1
(43) Pub. Date: Oct. 8, 2009

(54) System and method of increasing the output energy of an electrical motor by transferring the output energy through a plurality of hydraulic networks to create a continuous electrical cycle

(76) Inventor: Ed Gilbert, JR., Dallas, GA (US)

Correspondence Address: ED GILBERT JR., 431 SILVERLEAF LANE, DALLAS, GA, 30157, US

(21) Appl. No.: 12/170,493

(22) Filed: Jul. 10, 2008

Related U.S. Application Data
(63) Continuation of application No. 12/061,471, filed on Apr. 2, 2008.

(51) Int. Cl. F02B 63/04

(52) U.S. Cl. 290/1 R

(57) ABSTRACT

Today, the world is faced with an energy crisis. There are needs for improved ways to conserve energy, increase efficiency of present systems and create a new way of controlling energy.

One way to combat this problem is to create a system which utilizes any form of kinetic energy (ex. water current and wind) and transfer its energy through a plurality of hydraulic networks to increase energy efficiency. A more desirable solution is to utilize an electrical motor coupled with a plurality of hydraulic networks and an electrical charging system. This system can be configured to sustain continuous independent (residential) or commercial power for various applications as well as all power equipment, cars, etc.

This motor/hydraulic/charge coupling not only provides the most cost-effective means of power, but helps saves the environment as well.

### PARENT CASE TEXT

This is a continuation to application Ser. No. 12/061,471 filed Apr. 2, 2008

### REFERENCES CITED

### US Patent Documents

| | | |
|---|---|---|
| 386116 | July, 1888 | Du Bois |
| 3938332 | February, 1976 | Roces |
| 5647721 | July, 1997 | Rohrbaugh |
| 6860571 | March, 2005 | Sheetz |
| 7331411 | February, 2008 | Shevket |
| 3787150 | January, 1975 | Sarich |
| 6481990 | November, 2002 | Wong et al |

### BACKGROUND OF THE INVENTION

1. Field of the Invention

This invention relates generally to an electric motor coupled with a plurality of hydraulic networks of increasing size to increase the overall output energy of the motor being utilized. The final output energy is utilized as the primary source to drive an electrical charging device to produce enough energy to continuously sustain the entire system for an exponential amount of time. As the load on the system increase, another hydraulic network can be added to the system to compensate the increase without any adverse affect to the energy requirements of the system due to the low friction/pressure ratio.

2. Description of the Related Technology

Hydraulics have been used for years to do work where normal mean of power fall short. Since hydraulics creates an exponential force, the force will always be greater than the energy required to keep the system in motion.

### SUMMARY OF THE INVENTION

The present invention provides a primary drive system for creating perpetual motion. In a preferred embodiment, the system comprises of an electric motor coupled with a plurality of hydraulic networks of increasing size (pistons, vanes, etc.). The electric motor is directly or indirect mounted to a rotational mechanism contained within the makeup of the hydraulic networks. The rotational energy of the electric motor/hydraulic network is transferred to an electrical current producing output device such as an alternator/generator or charging system. The energy created by the electrical current producing output device (alternator/generator) is then routed back to the energy storage source (ex. battery).

A system and method of this nature is suitable for all known applications where physical motion needs to be achieved because the final output energy is far greater than input energy and the energy needed to substance thereof. Example: An electric motor exerts a 2 pound force @ 30 amps max. Electrical input, oil the fluid in a 1 inch cylinder. That energy is transferred to another cylinder with a 10 inch diameter piston, the final output energy will be 200 pounds of force. In turn, this amount of force can provide enough force to turn high output generators or alternators to sustain almost any electrical requirements.

### BRIEF DESCRIPTION OF DRAWINGS

FIG. 1 is a fragmentary cross-sectional view of the electric motor/hydraulic networks.

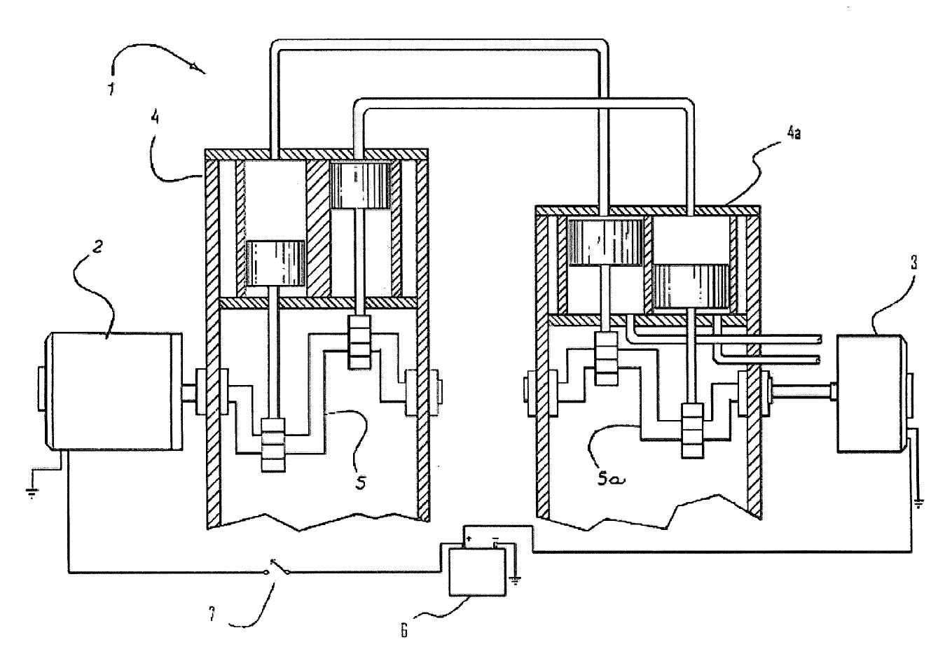

### DETAILED DESCRIPTION OF PREFERRED EMBODIMENT(S)

Referring now to the drawing, wherein like reference numerals designate corresponding structure throughout the view, a system and method 1 that is constructed according to a preferred embodiment of the invention includes an electric motor 2, energy output producing device (ex. alternator/generator) 3 with a plurality of hydraulic networks 4, 4a attached thereto and an energy storage unit/source (ex. battery) 6.

Once the opened circuit 7 is closed, the energy storage unit/source (ex. battery) 6 energizes the motor 2 which causing rotation of the crankshaft 5 of the primary hydraulic network 4, in turn, causing rotation of the crankshaft 5a of the secondary hydraulic network 4a at an exponentially greater force due to the increased pistons size of the network. The final rotational assembly is used to transfer energy to do work, on the energy output producing device 3. The energy output producing device (alternator/generator) 3 transfers a usable current or charge to the energy storage unit/source (ex. battery) 6 to complete the cycle. Once initiated, the system and method 1 will continue its cycle until the limitations of matter within the system is reached.

It is to be understood that all aspects of the hydraulic networks are proportionately sized in order to satisfy the Laws of Physics (ex. Conservation of energy). Also, even though numerous characteristics and advantages of the present invention have been set forth in the foregoing description, together with details of the structure and function of the invention, the disclosure is illustrative only, and changes may be made in detail, especially in the maters of shape, size and arrangement of parts within the principles of the invention to the full extent indicated by the broad general meaning of the terms in within the appended claims are expressed.

What I claim is:

1. A system and method of increasing the output energy of an electric motor by transferring the output energy through a plurality of hydraulic networks or a plurality of hydraulic network of increasing piston diameter and decreasing cylinder height, whereas the final output energy is utilized to sustain continuous electrical current through the system thus creating perpetual motion of the current regardless of physical load to the system.

2. The motor in claim 1 is energized by a stored source of electrical DC current (battery) or AC current (household) to begin rotation of the motor/hydraulic network.

3. The motor/hydraulic network in claim 1 is attached directly or indirectly to a current producing output device such as an alternator or generator.

4. The current producing output device (ex. alternator/generator) in claim 3 is directly or indirectly connected to the electrical storage source (ex. battery) in claim 2 in a manner in which a continuously electrical current is transferred.

5. The rotational energy in claim 2 causes the current producing output device to produce a continuous charge that is adequate to sustain the electrical requirements of the system.

6. A current amplification or conditioning device can be implemented within the system in claim 1 to increase the overall efficiency of the system thereof.

7. The hydraulic networks in claim 1 can be configured to inter-connect in series, parallel, or mixed (series/parallel) to achieve a desired output.

8. The final output energy in claim 1 can be transferred through a transmission to increase the usability of the system.
